(19) United States
(12) Patent Application Publication
(10) Pub. No.: US 2026/0021654 A1
(43) Pub. Date: Jan. 22, 2026

(54) SYSTEMS AND METHODS FOR GLUING AND LAMINATING

(71) Applicant: ZHEJIANG JIAOWANG TECHNOLOGY CO., LTD., Jinhua (CN)

(72) Inventor: Xiangdong GONG, Jinhua (CN)

(73) Assignee: ZHEJIANG JIAOWANG TECHNOLOGY CO., LTD., Jinhua (CN)

(21) Appl. No.: 18/824,871

(22) Filed: Sep. 4, 2024

(30) Foreign Application Priority Data
Jul. 19, 2024 (CN) 202410970067.1

(51) Int. Cl. B32B 41/00

(52) U.S. Cl. CPC B32B 41/00; B32B 2309/04; B32B 2309/72

(57) ABSTRACT

Embodiments of the present disclosure provide an automatic production line for gluing and laminating, a method, a system and medium for gluing and laminating. The automatic production line includes at least one production line unit and a central control processor. The at least one production line unit includes a gluing unit, a laminating unit, a baking unit, a pressing unit, or an image acquisition unit. The central control processor is configured to: determine, based on an image data set, gluing quality data, wherein the image data set includes an original image data set and a gluing image data set; determine, based on the gluing quality data, at least one control parameter; generate, based on the at least one control parameter, a control instruction, and send the control instruction to the at least one production line unit to perform a production control.

### CROSS-REFERENCE RELATED TO APPLICATION

This application claims priority to a Chinese application No. 202410970067.1, filed on Jul. 19, 2024, the entire contents of which are incorporated herein by reference.

### TECHNICAL FIELD

The present disclosure relates to the technical field of production lines, and in particular, to an automatic production line for gluing and laminating, a method, a system and medium for gluing and laminating.

### BACKGROUND

Laminating technology is used to cover a layer of protective film on a surface of a material, which may be mainly used for decoration and protection, and may improve the glossiness and strength of the surface of the material, making a product more beautiful and durable. Laminating technology is closely related to glue, which may be usually used for fixing and connecting in a film laminating process, and the glue used needs to have good adhesion and durability to ensure the permanence and stability of laminating effect. In the integrated automatic production line for gluing and laminating film, how to control each production process and ensure the production quality of laminated products is an urgent technical problem.

Therefore, it is expected to provide an automatic production line for gluing and laminating, a method, a device, and a medium, to intelligently control the production line, and at the same time, to reduce a production cost and improve the quality of the film laminating.

### SUMMARY

One or more embodiments of the present disclosure may provide a system of automatic production. The automatic production line may include: at least one production line unit and a central control processor. The at least one production line unit may include a gluing unit, a laminating unit, a baking unit, a pressing unit, or an image acquisition unit. The gluing unit may include a gluing device and a gluing control subsystem, the gluing device being configured to apply glue to a surface of a substrate based on a gluing instruction issued by the gluing control subsystem. The baking unit may include a baking device and a baking control subsystem, the baking device being configured to bake the substrate based on a baking instruction issued by the baking control subsystem. The laminating unit may include a film laminating device and a film laminating control subsystem, the laminating unit being configured to bond a film material to the surface coated with the glue based on a film laminating instruction issued by the film laminating control subsystem. The pressing unit may include a pressing device and a pressing control subsystem, the pressing device being configured to apply a pressure to the substrate and the film material to achieve a tight fit based on a pressing instruction issued by the pressing control subsystem. The image acquisition unit may include at least one monitoring device arranged at one or more locations of the system, the image acquisition unit being configured to acquire glue image data and an image data set of the substrate at one or more time points. The central control processor may be configured to: determine, based on the substrate image data set, gluing quality data, wherein the image data set includes an original image data set and a gluing image data set; determine, based on the gluing quality data, at least one control parameter of the system; and generate, based on the at least one control parameter, a control instruction and send the control instruction to one of the at least one production line unit to perform a production control.

One or more embodiments of the present disclosure may provide a method. The method may include: determining, based on an image data set, gluing quality data, wherein the image data set may be acquired by an image acquisition unit of an automatic production line, and the image data set includes an original image data set and a gluing image data set; determining, based on the gluing quality data, at least one control parameter; and generating, based on the at least one control parameter, a control instruction, and sending the control instruction to one of at least one production line unit to perform a production control, wherein the at least one production line unit may include a gluing unit, a laminating unit, a baking unit, a pressing unit, or the image acquisition unit.

One or more embodiments of the present disclosure may provide a device for controlling an automatic production line based on glue and film laminating, the device including at least one processor and at least one memory. The at least one memory may be configured to store computer instructions; and the at least one processor may be configured to perform the method for controlling an automatic production line based on glue and film laminating, as described in any of the embodiments of the present disclosure.

One or more embodiments of the present disclosure may provide a non-transitory computer-readable storage medium storing computer instructions. When reading the computer instructions in the storage medium, a computer may performs a method including: determining, based on an image data set, gluing quality data, wherein the image data set is acquired by an image acquisition unit of an automatic production line, and the image data set includes an original image data set and a gluing image data set; determining, based on the gluing quality data, at least one control parameter; and generating, based on the at least one control parameter, a control instruction, and send the control instruction to one of at least one production line unit to perform a production control, wherein the at least one production line unit includes a gluing unit, a laminating unit, a baking unit, a pressing unit, or the image acquisition unit.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary automatic production line for gluing and laminating according to some embodiments of the present disclosure;

FIG. 2 is a flowchart illustrating an exemplary process for controlling an automatic production line for gluing and laminating according to some embodiments of the present disclosure; and

FIG. 3 is a schematic illustrating an exemplary parameter determination model according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the terms “system,” “device,” and/or “module” used herein are one method to distinguish different components, elements, parts, sections, or assemblies of different levels in ascending order. However, the terms may be displaced by other expressions if they may achieve the same purpose.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, stated features, operations, elements, operations, and/or components, but do not exclude the presence or addition of one or more other integers, devices, behaviors, features, operations, elements, operations, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

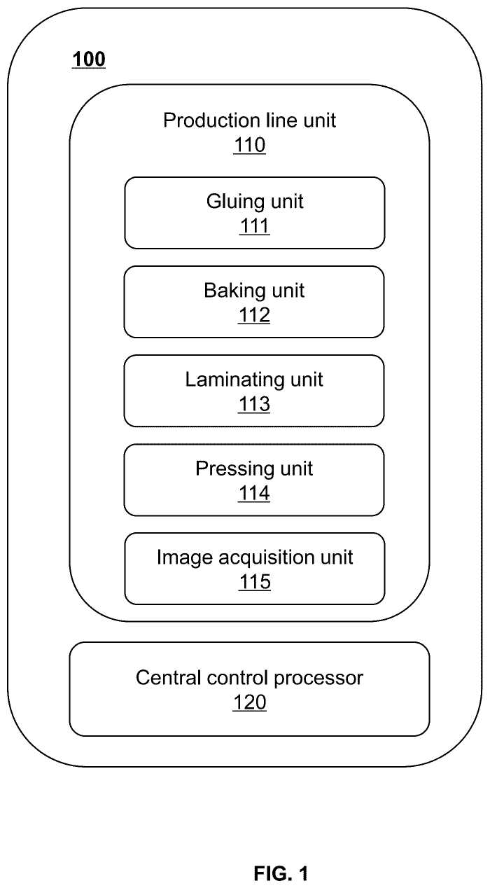

FIG. 1 is a schematic diagram illustrating an exemplary automatic production line for gluing and laminating according to some embodiments of the present disclosure.

As shown in FIG. 1, in some embodiments, an automatic production line 100 for gluing and laminating (also referred to as a system for gluing and laminating) may include at least one production line unit 110 and a central control processor 120.

In some embodiments, the at least one production line unit 110 may include a gluing unit 111, a baking unit 112, a laminating unit 113, a pressing unit 114, or an image acquisition unit 115.

The gluing unit 111 may be configured to perform a gluing process. The gluing process refers to a processing for applying glue to a material surface (e.g., a surface of a substrate). In some embodiments, the glue may include water-based glue and non-liquid glue such as paste-like glue, pasty glues flaky glue, film-like glue, or the like. In some embodiments, the water-based glue may include a polyvinyl alcohol-based water-based adhesive, an ethylene vinyl acetate-based water-based adhesive, an acrylic-based water-based adhesive, a polyurethane-based water-based adhesive, an epoxy-based water-based adhesive, a phenolic water-based adhesive, a silicone-based water-based adhesive, a rubber-based water-based adhesive, or the like, or a combination thereof. The foregoing descriptions relating to the types of glue are for illustrative purposes only and are not intended to limit the scope of the present disclosure.

In some embodiments, the gluing unit 111 may include a gluing device and a gluing control subsystem, the gluing control subsystem is configured to control the gluing device, and the gluing device is configured to apply glue to the surface of the substrate based on a gluing instruction issued by the gluing control subsystem. The substrate refers to a base of material required to manufacture a complete product. For example, the substrate may be used to make laminate flooring. In some embodiments, the gluing control subsystem may be communicatively connected with the central control processor 120 to perform a corresponding production control based on a control instruction issued by the central control processor 120.

In some embodiments, the gluing instruction may include one or more of a gluing amount, a gluing speed, a gluing frequency, or a gluing pressure, and thus the gluing control subsystem may control the gluing device to apply the surface of the substrate according to the one or more of the gluing amount, the gluing speed, the gluing frequency, or the gluing pressure. In some embodiments, the gluing control subsystem may control the gluing device to mix the glue with an appropriate amount of water to adjust the viscosity and the solid content of the glue. The solid content refers to a mass percentage of a remaining portion of an emulsion or coating after drying under one or more specified conditions relative to a total mass of the emulsion or coating.

In some embodiments, the gluing device may include a first conveyor belt and at least one gluing roller. In some embodiments, the gluing control subsystem may control the first conveyor belt to transfer the substrate, and control the gluing roller to apply the glue to the surface of the substrate on the first conveyor belt during transmission of the first conveyor belt. In some embodiments, the gluing control subsystem may control the first conveyor belt to transfer the glued substrate to other components (e.g., the baking unit 112) of the at least one production line unit 110.

The baking unit 112 may be configured to perform a baking process. In some embodiments, the baking unit 112 may include a baking device and a baking control subsystem. The baking control subsystem may be configured to control the baking device, and the baking device may be configured to bake the substrate based on a baking instruction issued by the baking control subsystem. For example, the baking device may bake the substrate that has been coated with glue.

In some embodiments, the baking control subsystem may be communicatively connected with the central control processor 120 to perform a corresponding production control based on the control instruction issued by the central control processor 120. In some embodiments, the baking instruction may include one or more of a baking temperature, a wind power, a wind speed, a baking time, or a baking mode, so that the baking control subsystem may control the baking device to bake the substrate according to the one or more of the specific baking temperature, the wind power, the wind speed, the baking time, or the baking mode.

In some embodiments, the baking device may include a second conveyor belt and a baking channel, and the second conveyor belt may pass through the baking channel.

In some embodiments, the baking control subsystem may control the second conveyor belt to transfer the substrate and control the baking channel to bake the substrate placed on the second conveyor belt during transmission of the second conveyor belt. The baking channel may heat the substrate using hot air or infrared rays to cure the glue applied on the substrate and enhance a bonding strength. In some embodiments, the baking temperature, the wind power, the wind speed, the baking time, the baking mode of the smart baking channel and/or the transfer speed of the second conveyor belt may be controlled by the baking control subsystem. In some embodiments, the baking control subsystem may control the second conveyor belt to transfer the baked substrate to other components (e.g., the laminating unit 113) of the at least one production line unit.

In some embodiments, the baking control subsystem may perform a multi-stage temperature control and wind power adjustment corresponding to the baking channel to regulate the baking temperature and the wind power of the baking channel. The laminating unit 113 may be configured to perform a film laminating process.

The film laminating process refers to a process for laminating a film to a surface of a material (e.g., the substrate). In some embodiments, the laminating unit 113 may include a film laminating device and a film laminating control subsystem, the film laminating control subsystem may be configured to control the film laminating device, and the film laminating device may be configured to bond a film material to the surface coated with the glue based on a film laminating instruction issued by the film laminating control subsystem. For example, the film laminating device may laminate the surface of the substrate after the glue on the surface of the substrate has been applied and baked.

In some embodiments, the film laminating control subsystem may be communicatively connected with the central control processor 120 to perform a corresponding production control based on the control instruction issued by the central control processor 120. In some embodiments, the film laminating instruction may include one or more of a film material dosage, a laminating speed, or a laminating pressure, so that the laminating control subsystem may control the film laminating device to laminate the substrate according to the one or more of the film material dosage, the laminating speed, or the laminating pressure.

In some embodiments, the film laminating device may include a third conveyor belt and at least one laminating roller. In some embodiments, the film laminating control subsystem may control the third conveyor belt to transfer the substrate and control the at least one film laminating roller to adhere the film material to the surface of the substrate on the third conveyor belt during transmission of the third conveyor belt. In some embodiments, the film laminating control subsystem may control the third conveyor belt to transfer the film-laminated substrate to other components (e.g., the pressing unit 114) of the at least one production line unit 110.

The pressing unit 114 may be configured to perform a pressing process. The pressing process refers to a process for applying a pressure to achieve a tight fit between at least two materials. In some embodiments, the pressing unit 114 may include a pressing device and a pressing control subsystem, the pressing control subsystem may be configured to control the pressing device, and the pressing device may be configured to apply a pressure to the substrate and the film material to achieve a tight fit based on a pressing instruction issued by the pressing control subsystem. For example, the pressing device may perform a pressing process on the laminated substrate and the film material on the surface. The pressing process may be conducive to better penetration and adhesion of a glue coating layer on the surface of the substrate, ensuring that the bonding portion is firm and reliable.

In some embodiments, the pressing control subsystem may be communicatively connected with the central control processor 120 to perform a corresponding production control based on the control instruction issued by the central control processor 120. In some embodiments, the pressing instruction may include one or more of a transfer speed or a pressing pressure, so that the pressing control subsystem may control the pressing device to press the substrate according to the one or more of the transfer speed or the pressing pressure.

In some embodiments, the pressing device may include a fourth conveyor belt and at least one set of pressing rollers. In some embodiments, the pressing control subsystem may control the fourth conveyor belt to transfer the substrate and control the at least one set of pressing rollers to apply a pressure to the substrate and the film material to achieve the tight fit to enhance the tightness of the fit between the film material and the surface of the substrate and the surface flatness of the film-laminated substrate during transmission of the fourth conveyor belt. In some embodiments, the pressing control subsystem may control the fourth conveyor belt to transfer the pressed substrate to other components (e.g., a subsequent processing unit) of the at least one production line unit 110.

In some embodiments, one set of pressing rollers may include an upper pressing roller and a lower pressing roller, and the one set of pressing rollers may perform a pressing process on a material between the upper and lower pressing rollers.

In some embodiments, the first conveyor belt, the second conveyor belt, the third conveyor belt, and the fourth conveyor belt may be sequentially connected to each other to transfer the substrate. In some embodiments, the first conveyor belt, the second conveyor belt, the third conveyor belt, and the fourth conveyor belt may be portions of an overall conveyor belt, and the present disclosure is not limited herein.

In some embodiments, the at least one production line unit 110 may also include a cutting unit (not shown in FIG. 1), and the cutting unit may be configured to cut the substrate. In some embodiments, before performing the pressing process, the cutting unit may cut the film-laminated substrate according to a product specification requirement to obtain a cut substrate. The pressing unit 114 may perform the pressing process on the cut substrate, i.e., the substrate may be cut into a plurality of portions (e.g., sub-substrates) that satisfy the product specification requirement prior to the pressing unit 114 performing the pressing process. In some embodiments, the cutting unit may include an automated cutting device.

In some embodiments, the at least one production line unit 110 may further include one or more subsequent processing units (not shown in FIG. 1), the one or more subsequent processing units may be configured to perform one or more subsequent processes on the pressed substrate. In some embodiments, the subsequent processes may include a cooling process, a sanding process, a trimming process, or the like, or any combination thereof. The cooling process may make the bonding effect between the film material and the substrate more stable. The sanding process may make the surface of the film-laminated substrate more flat. The trimming process may make an edge of the film-laminated substrate more fine.

The image acquisition unit 115 may be configured to acquire an image data set. In some embodiments, the image acquisition unit 115 may include at least one monitoring device deployed at one or more locations of the automatic production line. The at least one monitoring device may include a camera, or the like. In some embodiments, the at least one monitoring device may be deployed in an area where each of the at least one production line unit 110 is located. For example, the monitoring device may be deployed at a point within an area where each of the gluing unit 111, the baking unit 112, the laminating unit 113, and the pressing unit 114 is located.

In some embodiments, the image acquisition unit 115 may be configured to acquire glue image data and an image data set of the substrate on the automatic production line at one or more time points. In some embodiments, the image data set may include an original image data set and a gluing image data set. In some embodiments, the monitoring device may acquire image data at a specific imaging frequency.

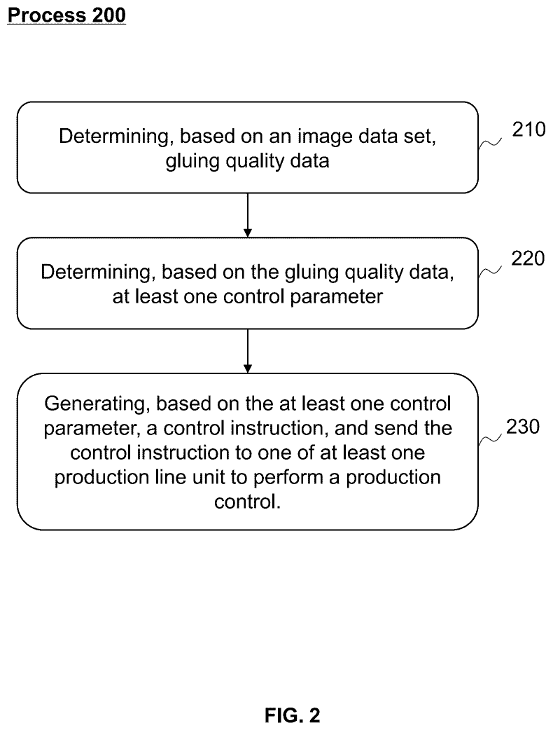

More details regarding the glue image data and the image data set may be found in other contents of the present disclosure (e.g., description in connection with FIG. 2).

The central control processor 120 may be configured to control the at least one production line unit 110. The central control processor 120 may be communicatively connected with the control subsystems of other components (e.g., the gluing unit 111, the baking unit 112, the laminating unit 113, the pressing unit 114, and the image acquisition unit 115) in the at least one production line unit 110, respectively to obtain data and/or information from the other components in the at least one production line unit 110. The central control processor 120 may process the data and/or information obtained from the other components in the at least one production line unit 110. The central control processor 120 may execute program instructions based on the data, information, and/or processing results to implement one or more functions described in the embodiments of the present disclosure. For example, the central control processor 120 may be communicatively connected with the gluing control subsystem of the gluing unit 111 to send a target gluing parameter to the gluing control subsystem, and the gluing control subsystem may control the gluing device to perform the gluing process based on the target gluing parameter. As another example, the central control processor 120 may be communicatively connected with the baking control subsystem of the baking unit 112 to send a target baking parameter to the baking control subsystem, and the baking control subsystem may control the baking device to perform the baking process based on the target baking parameter. As another example, the central control processor 120 may be communicatively connected with the film laminating control subsystem of the laminating unit 113 to send a target film laminating parameter to the film laminating control subsystem, and the film laminating control subsystem may control the film laminating device to perform the film laminating process based on the target film laminating parameter. As another example, the central control processor 120 may be communicatively connected with the pressing control subsystem of the pressing unit 114 to send a target pressing parameter to the pressing control subsystem, and the pressing control subsystem may control the pressing device to perform the pressing process based on the target pressing parameter.

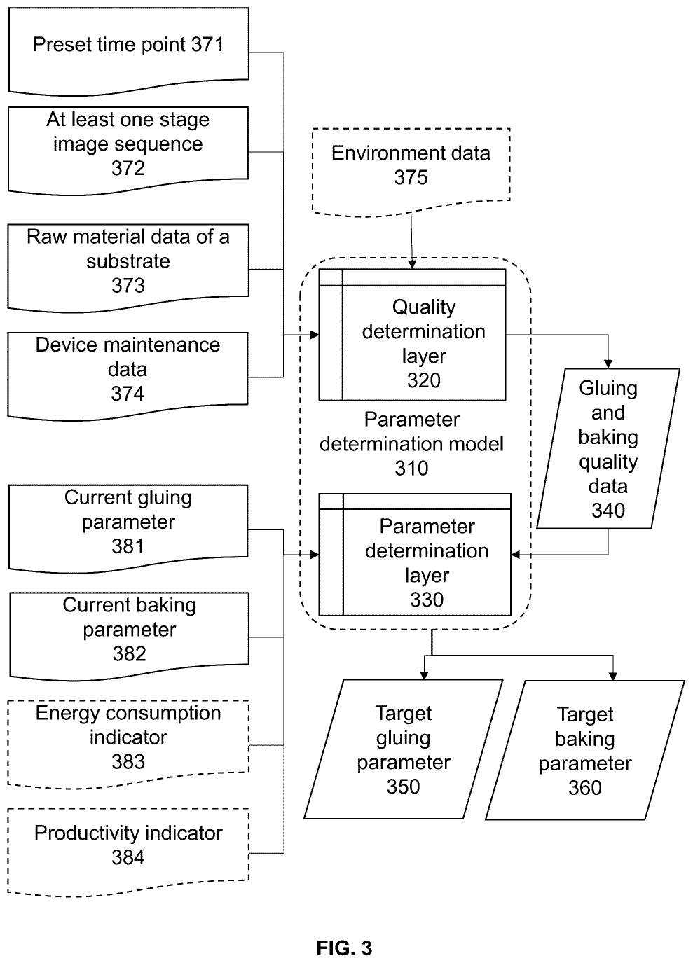

More details regarding the target gluing parameter, the target baking parameter, the target film laminating parameter, the target pressing parameter, and the central control processor 120 may be found in other contents of the present disclosure (e.g., descriptions in connection with FIG. 2˜FIG. 3).

It should be noted that the above description of the automatic production line 100 for gluing and laminating and units thereof is provided only for descriptive convenience, and does not limit the present disclosure to the scope of the cited embodiments.

FIG. 2 is a flowchart illustrating an exemplary process for controlling an automatic production line for gluing and laminating according to some embodiments of the present disclosure. As shown in FIG. 2, process 200 includes the following operations. In some embodiments, the process 200 may be performed by the central control processor 120 in the automatic production line 100 for gluing and laminating.

In 210, based on an image data set, gluing quality data may be determined.

The image data set refers to a data set consisting of a plurality of images each of which represents a substrate. The image data set may be acquired an image acquisition unit. For example, images of the substrate (i.e., images including the substrate) from a plurality of angles and at a plurality of time points may be acquired by a monitoring device disposed at each of at least one location of the automatic production line.

In some embodiments, the image data set may include an original image data set and a gluing image data set.

The original image data set may include at least one original image, and the original image refers to an image including the substrate that has not been processed by the automatic production line. In some embodiments, the original image data set may be acquired by the monitoring device set at a start location (e.g., a start location of a first conveyor belt) of the automatic production line.

The gluing image data set may include at least one gluing image, and the gluing image refers to an image including the substrate that has been subjected to a gluing process. In some embodiments, the gluing image data set may be acquired by a monitoring device disposed at the gluing unit (e.g., an end location of the first conveyor belt).

In some embodiments, the image data set acquired by the image acquisition unit may be pre-stored in a storage device, and the central control processor may obtain the image data set from the storage device. The storage device may be a storage device integrated with the central control processor, or may be an external storage device connected with the central control processor, e.g., a hard disk, an optical disk, or the like.

The gluing quality data refers to data that reflects the gluing quality of the substrate. The gluing quality may be a gluing effect exhibited on the substrate after the gluing unit has applied the glue to the substrate. In some embodiments, the gluing quality data may include gluing quality of a single substrate or gluing quality of a plurality of consecutive substrates.

In some embodiments, the gluing quality may be denoted by a gluing indicator. The gluing indicator is an indicator that assesses a condition of the gluing quality. The gluing indicator may include, but is not limited to, the uniformity, a bubble and impurity situation, a dry and wet inconsistency situation, a glue hanging and pulling situation, a coverage rate, a thickness deviation, or the like, or any combination thereof.

The uniformity refers to a distribution of a glue coating layer on the substrate. The glue coating layer refers to a layer formed after the glue is applied to the surface of the substrate. If the glue coating layer is not uniformly distributed on the substrate (including excessive or insufficient glue in a portion of the glue coating layer), it may result in insufficient adhesion or overflow of glue in a portion of the substrate.

The bubble and impurity situation may include whether there are bubbles and impurities in the glue coating layer. If bubbles or impurities are mixed in the gluing process, the continuity and beauty of the glue coating layer may be affected.

The dry and wet inconsistency situation may include whether there is dry and wet inconsistency in the glue coating layer. The wet and dry inconsistency means that the glue coating layer on the surface of the substrate is partially dry before it has been laminated. If there is dry and wet inconsistency, the adhesion of the glue coating layer may be affected. The wet and dry inconsistency situation may be related to the glue and the environment.

The glue hanging and pulling situation may include whether there is glue hanging and/or pulling in a gluing device and the gluing process. The glue hanging refers to a phenomenon of material adhesion in the production process due to various reasons. The glue pulling refers to a phenomenon that the glue is pulled into a filament during the gluing process. Improper cleaning or unreasonably setting of the gluing device may lead to the glue hanging.

The coverage rate refers to a proportion of an area (i.e., a gluing area) of the surface of the substrate that is covered by the glue coating layer to the surface of the substrate that needs to be glued. If the coverage rate is insufficient, a portion of the surface of the substrate may not have adhesion.

The thickness deviation refers to a degree that a thickness of the glue coating layer exceeds a specified range. If there is the thickness deviation, the dimensional stability and performance of a finished product may be affected.

In some embodiments, the central control processor may designate an evaluation content corresponding to at least one gluing indicator as the gluing quality data. For example, when the gluing indicator include the uniformity and the bubble and impurity situation, the evaluation content obtained with respect to the uniformity and the bubble and impurity situation may be used as the gluing quality data. Merely by way of example, the central control processor may determine that the gluing quality data includes that the glue coating layer is uneven, there are bubbles and impurities in the glue coating layer, or the like.

In some embodiments, the central control processor may determine the gluing quality data based on the image data set in a plurality of ways. For example, the central control processor may identify, via an image processing algorithm, an appearance pattern of the glue coating layer on the substrate in the image data set to determine the gluing quality data.

In some embodiments, the central control processor may determine the gluing quality data based on glue image data, the original image data set, and the gluing image data set. The glue image data refers to an image of glue before the glue is applied. In some embodiments, the glue image data may be obtained by the monitoring device provided at a location of a glue drum.

In some embodiments, the central control processor may determine the gluing quality data, based on the glue image data, the original image data set, and the gluing image data set through the image processing algorithm.

In some embodiments, the central control processor may compare, via the image processing algorithm, an original image in the original image data set with a corresponding gluing image to determine the evaluation content with respect to the gluing indicator.

In some embodiments, the image processing algorithm may include an edge detection algorithm, and the central control processor may assess the coverage rate and the uniformity of the glue by the edge detection algorithm. For example, the central control processor may extract a contour of the gluing area, determine a feature of the gluing area, and compare the feature to a standard template to determine whether the glue coating layer uniformly and completely covers the surface area of the substrate that needs to be glued. The standard template is set up to show the surface of the substrate after gluing in an ideal state. The feature of the gluing area may include a ratio of perimeter to acreage, etc. In some embodiments, the edge detection algorithm may include, but is not limited to, a Canny edge detection algorithm or a Sobel operator algorithm.

In some embodiments, the image processing algorithm may include a texture analysis algorithm, and the central control processor may identify a color distribution of the gluing image by the texture analysis algorithm to determine a bubble situation and uniformity. For example, the central control processor may convert the gluing image into Hue-Saturation-Value (HSV) color space, and segment the gluing area based on a color threshold range corresponding to the glue. Bubbles typically exhibit a specific texture pattern that differs significantly from the uniformly gluing area. In some embodiments, the central control processor may use a texture analysis (e.g., a gray level co-occurrence matrix (GLCM) texture feature) algorithm to identify a count of bubbles and a distribution of bubbles or a distribution of glue in the gluing area. The HSV color space makes it easier to separate color and luminance information. The color threshold range specific to the glue may be obtained based on the glue image data. For example, the glue may be determined as white based on the glue image data, and the central control processor may acquire a color threshold range corresponding to the white glue.

In some embodiments, the image processing algorithm may include a template matching algorithm, and the central control processor may detect a specific defect in the gluing area, e.g., a localized lack of glue, unevenness due to excessive glue, or the like, by the template matching algorithm. In some embodiments, the central control processor may establish a library of defect image templates including a plurality of defects (e.g., a lack of glue, excessive glue, etc.) and a corresponding image feature (which may include an original image feature corresponding to a reference original image of a same reference substrate and a gluing image feature corresponding to a reference gluing image). The central control processor may apply the template matching algorithm to compare the original image feature and the gluing image feature corresponding to the same substrate with the image feature from the library of defect image templates to position and mark a potential defect. The original image feature and the gluing image feature may be extracted from the original image and the gluing image corresponding to the same substrate. In some embodiments, the template matching algorithm may include, but is not limited to, a normalized cross-correlation (NCC) algorithm or a squared difference matching algorithm.

In 220, based on the gluing quality data, at least one control parameter may be determined.

The at least one control parameter refers to at least one parameter used to control the automatic production line for gluing and laminating. In some embodiments, the at least one control parameter may include one or more unit control parameters for controlling one or more units in the at least one production line unit. In some embodiments, the unit control parameter may include a target gluing parameter, a target baking parameter, a target film laminating parameter, and a target pressing parameter. or the like, or a combination thereof. More details regarding the target gluing parameter, the target baking parameter, the target film laminating parameter, and the target pressing parameter may be found in other contents of the present disclosure (e.g., description below).

In some embodiments, the central control processor may determine the at least one control parameter based on the gluing quality data in a plurality of ways. In some embodiments, the central control processor may determine the at least one control parameter based on a correspondence between the gluing quality data and the at least one control parameter. Different gluing quality data may correspond to different control parameters. For example, when the gluing quality data includes an insufficient coverage rate or uneven gluing, the at least one control parameter may include increasing the amount of gluing, and increasing a pressure of a gluing roller. The correspondence between the gluing quality data and the at least one control parameter may be set in advance based on historical data or priori knowledge.

The automatic production line may also be tested to detect possible problems with the automatic production line in time and make adjustments.

The test may be performed periodically. For example, after the automatic production line operates for a time period, or after the automatic production line produces a certain count of finished products, the performance of each production unit on the automatic production line may be tested by a testing material. A time interval between two tests or the count of finished products may be referred to as a test cycle.

The test cycle may be determined in a plurality of ways. In some embodiments, the test cycle may be determined based on historical data or human settings.

In some embodiments, the image data set may also include a film laminating image data set, and the at least one control parameter may include the test cycle. In some embodiments, the central control processor may obtain film laminating quality data based on the film laminating image data set; and based on the gluing quality data, the film laminating quality data, and production quality data, determine the test cycle.

In some embodiments, the test may be a process for testing the performance of the gluing unit and the baking unit by the test material (e.g., a substrate with a large acreage). For example, by performing a gluing process on a test material, the gluing quality of the test material may be checked, including whether the amount of gluing is uniform, and whether there is any glue hanging. If there is the glue hanging, the gluing device may be adjusted and the gluing roller may be cleaned. As another example, by performing a baking process on the test material after the gluing process, a baking quality (e.g., determination of the glue color) of the test material may be determined, including whether the glue on the surface of the substrate becomes transparent. If the glue on the surface of the substrate of the test material is transparent, the baking unit may be continued to be used. If the glue on the surface of the substrate of the test material is still a large piece of white color, it is necessary to adjust the baking temperature and the speed of the conveyor belt, until the glue on the surface of the substrate becomes transparent.

In some embodiments, the central control processor may execute a testing process based on the determined test cycle to detect the gluing quality and the baking quality of the test material and to adjust the control parameter or a device situation of the at least one production line unit in response to a quality problem.

The film laminating image data set may include at least one laminating image. The film laminating image refers to an image including a film-laminated substrate. In some embodiments, the film laminating image data set may be acquired at one or more time points by a monitoring device disposed at the laminating unit (e.g., an end position of a third conveyor belt).

The film laminating quality data refers to data that reflects the film laminating quality of the substrate. The film laminating quality refers to a film laminating effect of the laminating unit after laminating a film material onto the substrate. In some embodiments, the film laminating quality data may include the film laminating quality of a single substrate, or may include the film laminating quality of a plurality of consecutive substrates.

In some embodiments, the film laminating quality may be denoted by a film laminating indicator. The film laminating indicator refers to an indicator that assess the film laminating quality. The film laminating indicator may include, but is not limited to, whether the coverage is complete, wrinkles and creases, misalignment, tears and breaks, uneven penetration of glue, or the like, or any combination thereof.

Whether the coverage is complete refers to whether the film material is completely adhered to the substrate. For example, when there are bubbles leaved or edges warped, the coverage is not complete. The wrinkles and creases refer to the wrinkles or creases produced during the film laminating process. The wrinkles and creases exist on the substrate after laminating may affect the flatness and appearance of the product. The misalignment refers to an offset pattern or size discrepancy between the film material and the substrate when a pattern or size of the film material and the substrate are not aligned. The tears and breaks refer to tears caused by an excessive pressure from the film laminating roller when laminating the film or by the quality of the film material itself. The uneven penetration of glue refers to the uneven penetration of glue underneath the film material, resulting in poor bonding or uneven light transmission in certain areas. The problem of uneven penetration of glue resulting in uneven transmittance is especially important for products that require transparency.

In some embodiments, the central control processor may designate the evaluation content corresponding to the at least one film laminating indicator as the film laminating quality data. For example, when the film laminating indicator include whether the coverage is complete and wrinkles and creases, the evaluation content obtained with respect to whether the coverage is complete and the wrinkles and creases may be used as the film laminating quality data. Merely by way of example, it may be determined that the film laminating quality data includes incomplete coverage and presence of wrinkles and creases.

In some embodiments, the determination of the film laminating quality data may be similar to the determination of the gluing quality data.

In some embodiments, the central control processor may determine, based on the film laminating image data set, the film laminating quality data through the image processing algorithm.

In some embodiments, the central control processor may determine, based on the film laminating image data set, the evaluation content corresponding to the film laminating indicator through the image processing algorithm.

Because uneven surfaces result in variations in reflection patterns, the central control processor may assess a gloss by analyzing a distribution and intensity of areas of high light reflection.

In some embodiments, the image processing algorithm may include an image luminance analysis algorithm and a contrast analysis algorithm (e.g., including a global contrast analysis algorithm and a local contrast analysis algorithm), and the central control processor may employ the image luminance analysis algorithm and the contrast analysis algorithm to identify uneven or wrinkled areas on the surface of the film-laminated film material in the film laminating image. Luminance analysis refers to determining an average or median luminance of the entire image.

In some embodiments, the image luminance analysis algorithm may include performing a luminance analysis based on a local luminance variance. For example, the central control processor may divide the film laminating image into a plurality of small areas (e.g., using a sliding window technique), determine an average luminance for each small area, and then observe the luminance distribution by plotting a luminance map based on the average luminance of each small area. Since uneven or defective areas typically result in localized luminance that is significantly different from surrounding areas, uneven or wrinkled areas of the surface of the film-laminated film material in the film laminating image may be identified based on the luminance distribution. Contrast analysis is analogous to luminance analysis.

In some embodiments, the central control processor may convert the image to a frequency domain (e.g., via a Fourier transform) and analyze a high-frequency component to identify film laminating bubbles. Defects (e.g., the film laminating bubbles) in the film laminating indicator often produce specific patterns in a spectrum, and by comparing a difference between a spectrum of a standard lamination and a detected spectrum, defects such as tiny bubbles that are difficult to observe directly in the time-domain image may be revealed. The standard lamination may be an ideal condition of the substrate after film laminating.

The production quality data refers to data that reflects a quality of a finished product. In the course of working of the automatic production line, an image of the substrate obtained by a monitoring device may not reflect all problems in the production process. Therefore, in some embodiments, the production quality data may be obtained by manual sampling. In this embodiment, the production quality data may be manually scored.

The sampling process may be realized by the automatic production line. In some embodiments, the automatic production line may include a robotic arm, and the robotic arm may be configured to sample the finished product based on a sampling instruction issued by the central control processor. In some embodiments, the central control processor may be configured to: control the robotic arm to sample the finished products based on a sampling parameter to obtain at least one sample product; and determine the production quality data based on the at least one sample product.

The robotic arm may be connected to the central control processor for receiving the sampling instruction issued by the central control processor. The finished product is a product after production is completed, i.e., a product after gluing, baking, film laminating, and pressing. The sample product may be a product sampled from the finished products.

The sampling instruction may be an instruction that controls the robotic arm to sample the finished products. In some embodiments, the sampling instruction may include the sampling parameter, and the sampling parameter may be a parameter for sampling the finished products. In some embodiments, the sampling parameter may include at least one of a sampling frequency, a sampling interval, or a sampling count.

The sampling frequency refers to a count of samples taken per unit of time (e.g., 2 hours, 6 hours, one day, etc.). Then sampling count refers to a count of sample products taken in a course of a single sampling. A plurality of sample products may be taken in the course of the single sampling. The sampling interval refers to a count of products produced in an interval between two adjacent sample products taken in the course of the single sampling.

In some embodiments, the central control processor may determine the sampling parameter based on the gluing quality data, the film laminating quality data, and/or gluing and baking quality data. More details regarding the gluing and baking quality data may be found in other contents of the present disclosure (e.g., description below).

In some embodiments, the central control processor may determine a sampling reference score based on a gluing quality score corresponding to the gluing quality data, a film laminating quality score corresponding to the film laminating quality data, and a gluing and baking quality score corresponding to the gluing and baking quality data; and determine the sampling parameter based on the sampling reference score.

The gluing quality score refers to scoring data used to measure the gluing quality. The film laminating quality score refers to scoring data used to measure the film laminating quality.

In some embodiments, the central control processor may determine the gluing quality score based on a gluing indicator. In some embodiments, the central control processor may set one or more quantitative criteria for the gluing indicator. For example, the quantitative criteria may include designating a gluing unevenness rate of more than 5% as an anomaly and a coverage rate of more than 5% as an anomaly. The central control processor may set one or more scoring criteria for each gluing indicator, and determine the gluing quality score based on the scoring criteria. For example, different scores may be assigned to specific values of the uneven rate, the temperature deviation, etc. (e.g., the higher the uneven rate, the lower the score), the central control processor may perform a weighted summation on the score of the each gluing indicator to obtain the gluing quality score, and the weights corresponding to the gluing indicators may be set in advance. Merely by way of example, in the gluing indicators, the higher coverage rate, the better uniformity, the fewer bubbles, and the fewer defects may correspond to the higher gluing quality score. In some embodiments, the central control processor may also look up a table based on the each gluing indicator to determine the gluing quality score.

In some embodiments, the central control processor may determine the film laminating quality score based on the film laminating indicator. In some embodiments, the central control processor may set one or more quantitative criteria and one or more scoring criteria for each film laminating indicator, and determine the film laminating quality score based on the scoring criteria. For example, different scores are assigned to specific values for incomplete coverage, misalignment, etc. (e.g., the more severe the misalignment, the lower the score), finally the central control processor may perform a weighted summation on the score of the each film laminating indicator to obtain the film laminating quality score, and the weights corresponding to different laminating indicators may be set in advance. Merely by way of example, the more complete coverage, the fewer misalignment, the fewer wrinkles and creases, the better penetration uniformity of glue, and the fewer defects in the film laminating indicator may correspond to the higher film laminating quality score. In some embodiments, the central control processor may also look up a table based on the each film laminating indicator to determine the film laminating quality score.

In some embodiments, if the gluing quality score is less than a preset gluing quality threshold or the film laminating quality score is less than a preset film laminating quality threshold, the central control processor may control the at least one production line unit to shut down and trim. This is because if the gluing quality data or the film laminating quality data is lower than the corresponding quality threshold, the gluing quality or the film laminating quality may be very poor, and the quality of the finished product may not be good, so continuing to produce products may only waste material. The gluing quality threshold and the film laminating quality threshold are preset thresholds of the gluing quality score and film laminating quality score for determining whether to shut down the production.

The gluing and baking quality score refers to scoring data used to measure the quality of gluing and baking. More details regarding the gluing and baking quality data and the gluing and baking quality score may be found in other contents of the present disclosure (e.g., description below).

In some embodiments, the central control processor may perform a weighted summation on the gluing quality score, the film laminating quality score, and the gluing and baking quality score to determine the sampling reference score. The sampling reference score refers to a score used to determine the sampling parameter. Merely by way of example, the central control processor may determine the sampling reference score based on equation (1):

$$S = {w}_{1} \times x + {w}_{2} \times y + {w}_{3} \times z , \qquad ( 1 )$$

wherein, S denotes the sampling reference score, x denotes the gluing quality score, y denotes the film laminating quality score, z denotes the gluing and baking quality score, and w₁, w₂, and w₃ are weights. w₁, w₂, and w₃ may be obtained based on historical data analysis. For example, if a probability that the final production quality does not meet the standard due to gluing quality problems in historical data is 30%, and a probability that the final production quality does not meet the standard due to film laminating quality problems is 60%, then w₂>w₁ may be set.

In some embodiments, if the sampling reference score is lower, the corresponding sampling parameter may be determined as a greater sampling frequency, a smaller sampling interval, and a greater sampling count. Conversely, if the sampling reference score is higher, the corresponding sampling parameter may be determined as a smaller sampling frequency, a larger sampling interval, a smaller sampling count. That is, the lower the reference score, the worse the quality of the sample finished products, and the more frequent sampling is needed.

In some embodiments, the production quality data may be determined by manually scoring at least one sample finished product. The production quality data may include a score for each of the at least one sample finished product.

In embodiments of the present disclosure, by sampling the finished product to determine the production quality data of the actual product, the test cycle can be more accurately determined for cyclic testing of the at least one production line unit.

In some embodiments, the central control processor may determine the test cycle based on the gluing quality data, the film laminating quality data, and the production quality data, via a vector database. In some embodiments, the central control processor may, based on the gluing quality data, the film laminating quality data, and the production quality data, construct a cycle feature vector, and based on the cycle feature vector, determine, from the vector database, a reference feature vector having a nearest distance with the cycle feature vector, and determine a reference test cycle corresponding to the reference feature vector as the test cycle corresponding to the cycle feature vector.

The gluing quality data, the film laminating quality data, and the production quality data may correspond to one substrate or may correspond to a plurality of substrates. The gluing quality data and the film laminating quality data may correspond to the same or the plurality of substrates. For example, the gluing quality data may include the gluing quality of 10 substrates, then the film laminating quality data may be the film laminating quality corresponding to the 10 substrates, and the production quality data may be scores of sample finished products sampled in a time period corresponding to the 10 substrates.

The vector database refers to a database that includes preset reference feature vectors and reference test cycles corresponding to the preset reference feature vectors. The vector database may be preset based on historical data or priori knowledge.

In the embodiment of the present disclosure, by determining the gluing quality data, the film laminating quality data, and the production quality data, it is possible to determine, based on the actual production quality of the production process, the most appropriate test cycle for the at least one production line unit in the production process to conduct a cyclic testing, detect possible problems in the at least one production line unit in time, and make adjustments.

In some embodiments, the automatic production line may further include an environmental data monitoring device, and the environmental data monitoring device may be configured to collect environmental data at one or more locations of the automatic production line. The environmental data monitoring device may be disposed in a location area where each unit of the automatic production line is located. For example, the environmental data monitoring device may be disposed in at least one location area where each of the gluing unit 111, the baking unit 112, the laminating unit 113, and the pressing unit 114 is located.

The environmental data refers to data embodying the environment within the automatic production line. In some embodiments, the environmental data may be obtained by the environmental data monitoring device. In some embodiments, the environmental data may include at least one of an ambient light, a temperature, a wind speed, or a humidity.

In some embodiments, the central control processor may determine a sequence of acquisition parameters for an image acquisition device based on the environmental data, the gluing quality data, the film laminating quality data, and the production quality data for at least one location of the automatic production line.

The sequence of acquisition parameters refers to a sequence of acquisition parameters corresponding to one or more image acquisition devices deployed at the one or more locations of the automatic production line. The acquisition parameters are parameters by which the one or more image acquisition devices acquire image data. In some embodiments, the acquisition parameters may include, but is not limited to a resolution, an acquisition frequency, a color depth, a field of view, an exposure time, a gain, a focus, a depth of field, or the like, or any combination thereof.

In some embodiments, the central control processor may determine the sequence of acquisition parameters in a plurality of ways based on at least one of the environmental data at at least one location of the automatic production line, the gluing quality data, the film laminating quality data, and the production quality data.

In some embodiments, the central control processor may dynamically adjust the exposure time and the gain based on lighting data of at least one location of the automatic production line, thereby ensuring that the image acquisition device may obtain clear images with a good contrast under different lighting conditions of the automatic production line. By dynamically adjusting the exposure time, the gain, and other acquisition parameters, changes in lighting may be effectively addressed.

In some embodiments, the central control processor may determine the focus and the depth of field in the acquisition parameters. Accurate focusing is critical for detecting details such as gluing uniformity, bubbles, creases, or the like. In some embodiments, the central control processor may determine the focus and the depth of field through autofocus or depth-awareness techniques to ensure clear imaging at varying working distances.

In some embodiments, when the gluing quality score of one glued substrate (i.e., a substrate after glue has been applied) is less than a gluing monitoring threshold, the central control processor may instruct the image acquisition device to increase a shooting frequency and a shooting resolution of a subsequent glued substrate, so as to timely discover and locate problems and take rapid adjustment measures. Because defects created during the gluing and film laminating processes may be very subtle, a high shooting resolution and a high shooting frequency may be needed to capture the details in images. In some embodiments, the central control processor may, in conjunction with a speed of the production line, select an appropriate frame rate to ensure that each critical production step may be captured in a timely manner, avoiding the occurrence of missed inspections. The speed of the production line may be a transfer speed of a conveyor belt for each unit (e.g., a first conveyor belt).

In some embodiments, when the gluing quality score of one glued substrate (i.e., a substrate after glue has been applied) is less than the gluing monitoring threshold, the central control processor may also instruct the image acquisition device disposed at the gluing unit to increase a shooting angle.

In some embodiments, the lower the gluing quality score, the larger the shooting frequency, the shooting resolution, or an increasing value of the shooting angle until a plurality of subsequently consecutive substrates (e.g., n substrates) have the gluing quality scores above the gluing monitoring threshold. n may be positively correlated to the speed of the conveyor belt (e.g., the first conveyor belt), and the gluing quality scores for the plurality of subsequently consecutive substrates may be redetermined based on retaken high-resolution images.

In some embodiments, the gluing monitoring threshold may be a preset threshold for determining whether enhanced monitoring of the glued substrate is required. The central control processor may perform a process on the film laminating quality score similar to the gluing quality score.

In some embodiments, when a production quality score is less than a production monitoring threshold, the central control processor may increase the shooting frequency and the shooting resolution of the image acquisition devices disposed at all locations on the current production line.

In some embodiments, when the gluing quality score of the glued substrate (i.e., the substrate after glue has been applied) is less than the gluing monitoring threshold, the central control processor may also adjust a focal length or a field angle of view according to an adjustment rule to ensure that the gluing area receives the best possible focus and sharpness. The adjustment rule may be a pre-set rule for adjusting the acquisition parameters.

In some embodiments, the central control processor may determine the sequence of acquisition parameters based on the environmental data at at least one location of the automatic production line. For example, when the environmental data at a location has a higher ambient temperature, a higher wind speed, and a lower humidity, the central control processor may increase the shooting frequency and the shooting resolution for the image acquisition device at the location. This is due to the fact that when the ambient temperature and the wind speed is high, and the humidity is low, the glue may solidify prematurely, which makes the film laminating process problematic.

In some embodiments of the present disclosure, the sequence of acquisition parameters of the image acquisition device can be determined by the environmental data or the like, and the acquisition of the image data set can be adjusted according to the acquisition parameters determined by the actual production situation and the environmental situation, thereby obtaining more accurate or more inclusive informative image data.

In 230, based on the at least one control parameter, a control instruction may be generated, and the control instruction may be sent to one of the at least one production line unit to perform a production control.

The control instruction refers to an instruction used to control the production line unit. In some embodiments, the control instruction may include a name corresponding to the production line unit and the control parameter. The central control processor may recognize a type of the control parameter and issue the control instruction to the corresponding production line unit based on the type of the control parameter. The type of the control parameter may include types of the gluing parameter, the baking parameter, the film laminating parameter, the pressing parameter, or the like. For example, for the target gluing parameter, the control instruction may be issued to the gluing unit and cause the gluing unit to execute the target gluing parameter.

In some embodiments of the present disclosure, by determining the gluing quality data and the control parameter, the production line can be intelligently controlled, while reducing the production cost and improving the laminating quality.

It should be noted that the above-mentioned description of process 200 is only for example and explanation, and does not limit the scope of application of the present disclosure. For those skilled in the art, various amendments and changes can be made to process 200 under the guidance of the present disclosure. However, these amendments and changes are still within the scope of the present disclosure.

In some embodiments, the image data set may further include a baking image data set, and the control parameter may include a target gluing parameter for controlling the gluing unit and a target baking parameter for controlling the baking unit. In some embodiments, the central control processor may determine a preset time point and obtain a stage image sequence corresponding to the preset time point; determine the gluing and baking quality data based on the stage image sequence and the substrate material data; and determine the target baking parameter and the target baking parameter based on the gluing and baking quality data.

The baking image data set may include at least one baking image, and the baking image may be an image including the substrate that has undergone the baking process. In some embodiments, the baking image data set may be acquired by the monitoring device disposed at the baking unit (e.g., an end location of the second conveyor belt).

The target gluing parameter refers to a parameter used to control the gluing unit. In some embodiments, the target gluing parameter may include at least one of a gluing amount, a gluing speed, and a gluing roller pressure.

The target baking parameter refers to a parameter used to control the baking unit. In some embodiments, the target baking parameter may include at least one of a baking temperature, a wind force, a wind speed, a baking time, and a baking mode. The baking mode may include hot air circulation, infrared baking, etc., and different glues may be adapted to different baking modes.

The preset time point refers to a time point preset for evaluating the combined quality of the gluing and baking. The preset time point may include a plurality of critical time points in the gluing and baking process. For example, the preset time point may include a time point when the glue has just been applied, a time point after baking for a time period, etc. For example, the preset time point may be a critical time point when the glue may change from a liquid to a solid state earlier. As another example, the preset time point may include a time point during the baking process when the viscosity of the glue reaches a criterion, a time point when the viscosity increases significantly, a critical time point when the glue is overbaked, or the like.

In some embodiments, the central control processor may extract the preset time point. For example, the preset time point may include a series of time points, such as the 10th second after the start of gluing, the 10th second after the gluing is completed, the 20th second after the gluing is completed, a time point of the start of feeding into the baking device, the 15th second after the start of the baking, and a time point of the completion of the baking. By determining the preset time point, image data of a plurality of time points are taken into account without having to process the image corresponding to each time point, which is able to improve the accuracy while guaranteeing the processing speed. Because gluing and baking processed include a series of consecutive actions, it is more reliable to consider gluing and baking in combination rather than only one of gluing or baking.

In some embodiments, the central control processor may determine the preset time point based on raw material data of the substrate, raw material data of the glue, a current gluing parameter, and a current baking parameter.

The raw material data of the substrate refers to data related to the substrate. The raw material data of the substrate may include a type, a water absorption rate, a surface roughness, or the like, of the substrate. The substrates of different materials react differently to gluing and baking. The raw material data of the glue refers to data related to the glue. The raw material data of the glue may include a type, a bond strength, a concentration of the glue, or the like. The current gluing parameter refers to a parameter of the gluing unit that currently performs the gluing process. For example, the current gluing parameter may include at least one of a current gluing amount, a current gluing speed, a current gluing frequency, and a current gluing roller pressure. The current baking parameter refers to a parameter of the baking unit currently performs the baking process. For example, the current baking parameter may include at least one of a current baking temperature, a current wind power, a current wind speed, a current baking time, and a current baking mode.

In some embodiments, the central control processor may determine the preset time point based on the raw material data of the substrate, the raw material data of the glue, the current gluing parameter, and the current baking parameter via a key point database. In some embodiments, the central control processor may construct a key feature vector based on the raw material data of the substrate, the raw material data of the glue, the current gluing parameter, and the current baking parameter; perform a vector match in the key point database based on the key feature vector, and obtain a reference time point corresponding to a reference feature vector closest to the key feature vector as a key time point. The key point database may be a preset database including a plurality of reference feature vectors and reference time points corresponding to the plurality of reference feature vectors. In some embodiments, the central control processor may conduct experiments on different raw material data of the substrate, raw material data of the glue, current gluing parameters, and current baking parameters in advance, and analyze and store the experimental data to construct the key point database.

In some embodiments, the central control processor may mix a preset fixed preset time point and a key time point determined from subsequent calculations as a final preset time point. For example, if it is preset that the time point of the start of the gluing, the time point of the completion of the gluing, or 10th second after the gluing is the fixed preset time point, the finalized preset time point accordingly includes these three time points.

The stage image sequence refers to a sequence consisting of at least one gluing image and at least one baking image corresponding to the preset time point. In some embodiments, the stage image sequence may include the at least one gluing image and the at least one baking image. In some embodiments, the central control processor may acquire gluing images and baking images corresponding to one or more preset time points (e.g., the series of time points described above) as the stage image sequence.

The gluing and baking quality data refers to data that considers both the gluing quality and the baking quality. Because the gluing and baking processes are the basis of the subsequent film laminating process, no matter whether there is a problem with any one of the gluing and baking processes may affect the quality of the subsequent film laminating process, and therefore the gluing and baking processes may be analyzed comprehensively.

In some embodiments, the gluing and baking quality data may include the gluing quality data, the baking quality data, and a combined quality of the gluing quality data and the baking quality data, and the combined quality of the gluing quality data and the baking quality data may be referred to as a gluing and baking quality score.

In some embodiments, the central control processor may determine the target gluing parameter and the target baking parameter based on the stage image sequence and the raw material data of the substrate through a parameter determination model. More details regarding the parameter determination model may be found in other contents of the present disclosure (e.g., description in connection with FIG. 3).

In some embodiments, the central control processor may dynamically adjust the target gluing parameter and the target baking parameter. In some embodiments, in response to a determining that the production quality score or the film laminating quality score is less than an adjustment threshold, the central control processor may dynamically adjust the target gluing parameter and the target baking parameter based on the film laminating quality data and the production quality data. For example, the central control processor may adjust the target gluing parameter and the target baking parameter for a next substrate based on the production quality score or the film laminating quality score of the previous substrate. As another example, the central control processor may adjust the target gluing parameter and the target baking parameter for the next substrate based on an average of production quality scores or an average of film laminating quality scores of a plurality of current substrates.

The production quality score refers to a score that evaluate the production quality data. More details regarding the film laminating quality score may be found in other contents of the present disclosure (e.g., description above). The adjustment threshold refers to a threshold for determining whether the target gluing parameter and the target baking parameter need to be adjusted. The adjustment threshold may include a production adjustment threshold and a film laminating adjustment threshold for judging the production quality score and the film laminating quality score, respectively. If the production quality score is less than the production adjustment threshold or the film laminating quality score is less than the film laminating adjustment threshold, it may be indicated that the quality of the finished product and the laminating film do not meet requirements, and adjustments are required to improve the production quality and the film laminating quality.

In some embodiments, the central control processor may determine, based on the film laminating quality data and the production quality data, an abnormal indicator; determine, based on the abnormal indicator, a parameter adjustment direction; and dynamically adjust, based on the parameter adjustment direction, the target gluing parameter and the target baking parameter.

The abnormal indicator refers to a gluing indicator or a film laminating indicator that is abnormal. For example, if a non-uniformity rate of gluing is more than 5%, a coverage rate is in a range of more than ±5%, or a hardening degree of the glue of the final product is low, the gluing indicator may be abnormal.

In some embodiments, the central control processor may construct an anomaly rule table based on historical data. The anomaly rule table may include the abnormal indicator and a parameter adjustment direction corresponding to the abnormal indicator. For example, when the abnormal indicator is the uniformity or coverage rate, the parameter adjustment direction may be to increase the amount of glue or to increase the gluing roller pressure. As another example, when the abnormal indicator is the hardening degree of the glue, the parameter adjustment direction may be to increase the baking temperature or to increase the wind.

In some embodiments, the central control processor may adjust the target gluing parameter and the target baking parameter one or more times according to a preset adjustment magnitude based on the parameter adjustment direction until no more abnormal indicators are present or until the production quality score greater than the production adjustment threshold and the film laminating quality score greater than the film laminating adjustment threshold.

The preset adjustment amplitude refers to a preset amplitude for adjusting parameters. The preset adjustment amplitude may be stepped. For example, the temperature is increased by 5 degrees for the first adjustment and only 3 degrees for the second adjustment to prevent over-adjustment.

In some embodiments, the central control processor may set a parameter adjustment range to set upper and lower limits of adjustment for each target gluing parameter and each target baking parameter to ensure that the adjustment of the parameters does not exceed a safe operating range of the device.

In some embodiments, the unit control parameter may further include the target film laminating parameter for controlling the laminating unit and the target pressing parameter for controlling the laminating unit. In some embodiments, the central control processor may obtain one or more candidate film laminating parameters and one or more candidate pressing parameters; and determine the target film laminating parameter and the target pressing parameter based on the current gluing parameter, the current baking parameter, historical film laminating quality data, historical gluing and baking quality data, the candidate film laminating parameters, and the candidate pressing parameters.

The target film laminating parameter refers to a parameter used to control the laminating unit. In some embodiments, the target film laminating parameter may include at least one of an amount of film material, a film laminating speed, and a film laminating roller pressure. The candidate film laminating parameters may be parameters to be determined as the target film laminating parameter.

The target pressing parameter refers a parameter used to control the pressing unit. In some embodiments, the target pressing parameter may include at least one of a pressing transfer speed and a pressing roller pressure. The candidate pressing parameters may be parameters to be determined as the target pressing parameter.

In some embodiments, the central control processor may randomly adjust the current film laminating parameter and the current pressing parameter to generate the candidate film laminating parameters and the candidate pressing parameters. The current film laminating parameter refers to a parameter for which the laminating unit currently performs the film laminating process. The current pressing parameter refers to a parameter for which the pressing unit currently performs the pressing process. A range of the randomly generated candidate film laminating parameters and candidate pressing parameters may not exceed a safe range. The safe range refers to a preset range for safe production of the automatic production line.

In some embodiments, the central control processor may determine a parameter adjustment range based on the current film laminating quality data and the production quality data; and determine the candidate film laminating parameters and the candidate pressing parameters based on the parameter adjustment range.

The parameter adjustment range may be a range consisting of an upper limit and a lower limit for parameter adjustment. For example, the amount of film material may vary within a range of ±10% of the current amount, and the film laminating speed may be adjusted within a range of ±5%. In some embodiments, the central control processor may firstly determine a baseline range, and then determine the parameter adjustment range by adjusting the current film laminating quality data and the production quality data based on the baseline range. The baseline range refers to a preset parameter range. The baseline range may be determined based on historical experience.

In some embodiments, the parameter adjustment range correlates to the current film laminating quality data and the production quality data. If the current film laminating quality data and the production quality data are poor, then it means that the current film laminating parameter and the current pressing parameter are not appropriate. At this point, if the parameter adjustment range is small, then the final adjustment effect of the target film laminating parameter and the target pressing parameter is also general. Thus, the lower the current film laminating quality data and the production quality data, the more the range may be expanded based on the baseline range to set the parameter adjustment range to a larger value.

In some embodiments, the central control processor may draw a set of candidate parameters, including the candidate film laminating parameter and the candidate pressing parameter, within a parameter adjustment range by means of a preset algorithm. In some embodiments, the preset algorithm may include a latin hypercube sampling (LHS) algorithm or a grid search algorithm. The LHS algorithm is an efficient sampling strategy that ensures a uniform distribution of samples across a full space, which facilitates exploration of the parameter space.

In some embodiments, the central control processor may score the candidate film laminating parameters and the candidate pressing parameters, and select a set of a candidate film laminating parameter and a candidate pressing parameter with a highest score as the target pressing parameter and the target pressing parameter.

In some embodiments, the central control processor may determine a score corresponding to each set of the candidate film laminating parameter and the candidate pressing parameter based on a scoring model.

In some embodiments, the scoring model is a machine learning model. In some embodiments, the scoring model may be a machine learning model with a custom structure. The scoring model may also be a machine learning model of other structure, such as a neural network model, etc. In some embodiments, an input of the scoring model may include the current gluing parameter, the environmental data at at least one location of the automatic production line, the raw material data of the substrate, the current baking parameter, the historical film laminating quality data, the historical gluing and baking quality data, the candidate film laminating parameter and the candidate pressing parameter, and an output may include a score corresponding to the candidate film laminating parameter and the candidate pressing parameter. More details regarding the current gluing parameter, the environmental data, the raw material data of the substrate, and the current baking parameter may be found in other contents of the present disclosure (e.g., description above). The historical film laminating quality data and the historical gluing and baking quality data are the film laminating quality data and the gluing and baking quality data in the historical data. The historical data may be data of a previous preset time period (e.g., the previous 1 h).

In some embodiments, the scoring model may be obtained by training a plurality of first training samples with first labels. The first training samples may be obtained in the historical data. In some embodiments, each of the first training samples may include a sample gluing parameter, sample environmental data, sample raw material data of the substrate, a sample baking parameter, sample historical film laminating quality data, sample historical gluing and baking quality data, a sample film laminating parameter, and a sample pressing parameter. The first label may be a score corresponding to the sample film laminating parameter and the sample pressing parameter in the first training sample. For example, for each set of the sample film laminating parameter and the sample pressing parameter, the film laminating quality score or the production quality score of the final finished product may be used as the score of the set of the sample film laminating parameter and the sample pressing parameter. As another example, a weighted summation of the film laminating quality score and the production quality score of the final finished product may be used as the score of the set of the sample film laminating parameter and the sample pressing parameter.

In some embodiments, after identifying the target film laminating parameter and the target pressing parameter, the central control processor may adjust the target film laminating parameter and the target pressing parameter based on the current gluing and baking quality data. For example, if it is recognized that there is too little glue applied or that the glue is slightly unevenly applied, the film laminating roller pressure may be increased and the rotation rate may be decreased during the film laminating process, which may result in the film material being more tightly fitted to the substrate.

In some embodiments, the central control processor may determine a defect indicator based on the current gluing and baking quality data; and dynamically adjust the target gluing parameter and the target baking parameter based on the defect indicator. In some embodiments, the central control processor may determine a corresponding parameter adjustment direction and magnitude from a defect rule table based on the defect indicator; and dynamically adjust the target film laminating parameter and the target pressing parameter based on the parameter adjustment direction and magnitude.

The defect indicator may include the gluing indicator and the film laminating indicator that are defective.

In some embodiments, the central control processor may, based on the defect indicator, look up the corresponding parameter adjustment direction and magnitude from the defect rule table; and dynamically adjust the target film laminating parameter and the target pressing parameter based on the parameter adjustment direction and magnitude. The central control processor may construct the defect rule table based on the historical data; and determine the adjustment direction and magnitude of the target film laminating parameter and the target pressing parameter based on the defect rule table. The defect rule table may include the defect indicator and the corresponding parameter adjustment direction and adjustment magnitude. For example, if the glue uniformity is 70%, it may be necessary to increase the film laminating pressure by 10% while decreasing the speed of the third conveyor belt by 15%.

In some embodiments, the central control processor may adjust the target film laminating parameter and the target pressing parameter based on the parameter adjustment direction and magnitude to determine an adjusted target film laminating parameter and an adjusted target pressing parameter.

In some embodiments, the central control processor may set the parameter adjustment range to set the upper and lower limits of adjustment for each target film laminating parameter and each target pressing parameter to ensure that the parameter adjustment does not exceed a safe operating range of the device.

In some embodiments of the present disclosure, by determining the target gluing parameter and the target baking parameter through determining the gluing and baking quality data, and by determining the target film laminating parameter and the target pressing parameter through the candidate film laminating parameters and the candidate pressing parameters, the unit control parameter of the production line unit can be determined according to an actual working situation and can be adjusted in time to ensure the quality of the finished products.

FIG. 3 is a schematic illustrating an exemplary parameter determination model according to some embodiments of the present disclosure.

In some embodiments, the central control processor may determine a target gluing parameter and a target baking parameter based on a parameter determination model.

The parameter determination model is a machine learning model. In some embodiments, the parameter determination model may be a machine learning model with a custom structure as described below. The parameter determination model may also be a machine learning model of another structure, such as a neural network model, a convolutional neural network model, a recurrent neural network model, or the like.

In some embodiments, an input of the parameter determination model may include a preset time point, at least one stage image sequence, raw material data of a substrate, device maintenance data, a current gluing parameter, and a current baking parameter, and an output may include a target gluing parameter and a target baking parameter. A plurality of images in one of the at least one stage image sequence may correspond to the same substrate. More details regarding the preset time point, the stage image sequence, the raw material data of the substrate, the current gluing parameter, the current baking parameter, the gluing and baking quality data, the target gluing parameter, and the target baking parameter may be found in other contents of the present disclosure (descriptions above), and is not repeated here. The device maintenance data may be operating state data of devices such as a gluing device and a baking device. For example, the device maintenance data may include device aging, wear and tear situations, etc. The device maintenance data may affect the quality of the finished product.

In some embodiments, the parameter determination model may be obtained by training a plurality of second training samples with second labels. The second training samples may be obtained in historical data. In some embodiments, each of the second training samples may include at least a sample preset time point, a sample stage image sequence corresponding to a sample substrate, sample raw material data of the sample substrate, sample device maintenance data, a sample gluing parameter, a sample baking parameter, and sample gluing and baking quality data. The second labels may include an actual gluing parameter and an actual baking parameter corresponding to the sample substrate in each of the second training samples. The second labels may be obtained from a test experiment corresponding to the sample substrate in each of the second training samples. For example, the central control processor may conduct experiments using a test substrate (the same as the sample substrate) with a plurality of sets of the gluing parameters and the baking parameters. If a set of the gluing parameter and the baking parameter makes the gluing and baking quality data obtained after gluing and baking of the test substrate meet a condition, the set of the gluing parameter and the baking parameter may be used as the second label corresponding to the second sample. The condition may be either no gluing and baking quality issues or a gluing and baking quality score greater than a threshold.

In some embodiments, the parameter determination model may include a plurality of processing layers. As shown in FIG. 3, the parameter determination model 310 may include a quality determination layer 320 and a parameter determination layer 330.

As shown in FIG. 3, an input of the quality determination layer 320 may include a preset time point 371, at least one stage image sequence 372 corresponding to the at least one substrate, raw material data of the substrate 373, and device maintenance data 374, and an output of the quality determination layer 320 may include gluing and baking quality data 340 corresponding to the at least one substrate. One stage image sequence may correspond to one piece of gluing and baking quality data.

As shown in FIG. 3, an input of the parameter determination layer 330 may include a current gluing parameter 381, a current baking parameter 382, and gluing and baking quality data 340 output by the quality determination layer 320, and an output of the parameter determination layer 330 may include a target gluing parameter 350 and a target baking parameter 360.

In some embodiments, the quality determination layer 320 and the parameter determination layer 330 may be obtained by separate training.

In some embodiments, third training samples of the quality determination layer 320 may include the sample preset time point, the sample stage image sequence corresponding to the sample substrate, the sample raw material data of the sample substrate, the sample device maintenance data, and third labels of the quality determination layer 320 may be the gluing and baking quality data corresponding to the sample substrate in the third training samples. The third labels may be obtained by a professional who actually measures or performs a judgment.

In some embodiments, fourth training samples of the parameter determination layer 330 may include the sample gluing parameter, the sample baking parameter, and the sample gluing and baking quality data, and fourth labels of the parameter determination layer 330 may be the actual gluing parameter and the actual baking parameter corresponding to the sample substrate of the fourth training samples. The central control processor may glue and bake the sample substrate with the sample gluing parameter and the sample baking parameter, and obtain the corresponding gluing and baking quality data as the sample gluing and baking quality data. The fourth labels may be obtained from a test experiment performed on the corresponding sample substrate in the fourth training samples.

In some embodiments, the output of the quality determination layer 320 may be used as the input of the parameter determination layer 330, and thus the quality determination layer 320 and the parameter determination layer 330 in the parameter determination model 310 may be jointly trained.

The exemplary joint training process may include: inputting the sample preset time point, the sample stage image sequence, the sample raw material data of the substrate, and the sample device maintenance data in the third training samples into an initial quality determination layer to obtain the gluing and baking quality data corresponding to the third training samples output by the initial quality determination layer; using the output of the initial quality determination layer as the sample gluing and baking quality data in the fourth training samples, and inputting the fourth training samples into an initial parameter determination layer to obtain the target gluing parameter and the target baking parameter output by the initial parameter determination layer; constructing a loss function based on the fourth training labels and the target gluing parameter and the target baking parameter output by the initial parameter determination layer, and synchronously updating parameters of the initial quality determination layer and the initial parameter determination layer; and obtaining a trained quality determination layer 320 and a trained parameter determination layer 330 by updating the parameters.

In some embodiments, the input of the quality determination layer 320 may also include environmental data 375 for at least one location of the automatic production line, and the input of the parameter determination layer 330 may also include an energy consumption indicator 383 and a productivity indicator 384. More details regarding the environmental data may be found in other contents of the present disclosure (e.g., description in connection with FIG. 2).

Merely by way of example, environmental variables (e.g., a workshop temperature, a workshop humidity, or an air pressure) may indirectly affect the effect of gluing and baking, and therefore the environmental data may be further considered when determining the target gluing parameter and the target baking parameter.

The energy consumption indicator refers to consumption of energy, such as electricity consumption, steam consumption, or the like. In some embodiments, the central control processor may consider energy efficiency optimization to reduce production costs while maintaining quality.

The productivity indicator refers to a productivity requirement. In some embodiments, the central control processor may consider a balance of a production speed and quality when adjusting the target gluing parameter and the target baking parameter based on an order requirement and a delivery date.

In some embodiments, the energy consumption indicator and the productivity indicator may be read directly from a system that manages the automatic production line.

In some embodiments of the present disclosure, by determining the target gluing parameter and the target baking parameter using the parameter determination model, a self-learning capability of a machine learning model may be utilized to find a law from a large amount of historical data and to obtain a relationship among the preset time point, the at least one stage image sequence, the raw material data of the substrate, the device maintenance data, the current gluing parameter, the current baking parameter, the target gluing parameter, the target baking parameter, etc., which improves the accuracy and efficiency of determining the target gluing parameter and the target baking parameter. The joint training of the quality determination layer and the parameter determination layer by the parameter determination model is in some cases conducive to solving the problem of the difficulty of obtaining labels when the quality determination layer is trained alone, and also enables the quality determination layer to obtain better gluing and baking quality data.

One or more embodiments of the present disclosure may provide a device for controlling an automatic production line for gluing and laminating. The device may include at least one processor and at least one memory. The at least one memory may be configured to store computer instructions; and the at least one processor may be configured to execute at least some of the computer instructions to implement a method for controlling an automatic production line for gluing and laminating as described in any of the embodiments of the present disclosure.

One or more embodiments of the present disclosure may provide a non-transitory computer-readable storage medium storing computer instructions. When reading the computer instructions in the storage medium, a computer may perform the method for gluing and laminating as described in any of the embodiments of the present disclosure.

Having thus described the basic concepts, it may be rather apparent to those skilled in the art after reading this detailed disclosure that the foregoing detailed disclosure is intended to be presented Merely by way of example and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

In addition, unless clearly stated in the claim, the order of processing element and sequence described in the present disclosure, the use of alphanumeric characters or the use of other names are not used to limit the order of the process and method of the present disclosure. Although some currently useful invention embodiments are considered to be discussed by various examples in the above disclosure, it should be understood that such details only serve the purpose of illustration, and additional claims are not limited to the disclosed embodiments. On the contrary, claims are intended to cover all amendments and equivalent combinations that meet the essence and scope of the present disclosure. For example, although the system components described above can be realized by hardware devices, it is also possible to only realize by the solution of software, such as installing the described system on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A system of automatic production, comprising:
at least one production line unit and a central control processor, wherein the at least one production line unit includes a gluing unit, a laminating unit, a baking unit, a pressing unit, or an image acquisition unit;
the gluing unit includes a gluing device and a gluing control subsystem, the gluing device being configured to apply glue to a surface of a substrate based on a gluing instruction issued by the gluing control subsystem;
the baking unit includes a baking device and a baking control subsystem, the baking device being configured to bake the substrate based on a baking instruction issued by the baking control subsystem;
the laminating unit includes a film laminating device and a film laminating control subsystem, the film laminating device being configured to bond a film material to the surface coated with the glue based on a film laminating instruction issued by the film laminating control subsystem;
the pressing unit includes a pressing device and a pressing control subsystem, the pressing device being configured to apply a pressure to the substrate and the film material to achieve a tight fit based on a pressing instruction issued by the pressing control subsystem;
the image acquisition unit includes at least one monitoring device arranged at one or more locations of the system, the image acquisition unit being configured to acquire glue image data and an image data set of the substrate at one or more time points; and
the central control processor is configured to:
determine, based on the image data set, gluing quality data, wherein the image data set includes an original image data set and a gluing image data set;
determine, based on the gluing quality data, at least one control parameter of the system; and
generate, based on the at least one control parameter, a control instruction; and
send the control instruction to one of the at least one production line unit to perform a production control.

2. The system of claim 1, wherein the image data set further includes a film laminating image data set, and the at least one control parameter includes a test cycle, and the central control processor is further configured to:
determine, based on the glue image data, the original image data set, and the gluing image data set, the gluing quality data;
obtain, based on the film laminating image data set, film laminating quality data; and
determine, based on the gluing quality data, the film laminating quality data, and production quality data, the test cycle.

3. The system of claim 1, wherein the image data set further includes a baking image data set, the at least one control parameter includes at least one unit control parameter, the at least one unit control parameter including a target gluing parameter used to control the gluing unit and a target baking parameter used to control the baking unit; and
the central control processor is further configured to:
determine a preset time point and obtain a stage image sequence corresponding to the preset time point, the stage image sequence including at least one gluing image and at least one baking image;
determine, based on the stage image sequence and substrate material data, gluing and baking quality data; and
determine, based on the gluing and baking quality data, the target gluing parameter and the target baking parameter.

4. The system of claim 3, wherein the at least one unit control parameter further includes a target film laminating parameter used to control the laminating unit and a target pressing parameter used to control the pressing unit, and the central control processor is further configured to:
obtain one or more candidate film laminating parameters and one or more candidate pressing parameters; and
determine, based on a current gluing parameter, a current baking parameter, historical film laminating quality data, historical gluing and baking quality data, the one or more candidate film laminating parameters. and the one or more candidate pressing parameters, the target laminating parameter and the target pressing parameter.

5. A method, comprising:
determining, based on an image data set, gluing quality data, wherein the image data set is acquired by an image acquisition unit of the automatic production line, and the image data set includes an original image data set and a gluing image data set;
determining, based on the gluing quality data, at least one control parameter; and
generating, based on the at least one control parameter, a control instruction, and send the control instruction to one of at least one production line unit to perform a production control, wherein the at least one production line unit includes a gluing unit, a laminating unit, a baking unit, a pressing unit, or the image acquisition unit.

6. The method of claim 5, wherein the image data set further includes a film laminating image data set, and the at least one control parameter includes a test cycle, and the method further comprises:
determining, based on glue image data, the original image data set, and the gluing image data set, the gluing quality data;
obtaining, based on the film laminating image data set, film laminating quality data; and
determining, based on the gluing quality data, the film laminating quality data, and production quality data, the test cycle.

7. The method of claim 5, wherein the image data set further includes a baking image data set, the at least one control parameter includes at least one unit control parameter, the at least one unit control parameter including a target gluing parameter used to control the gluing unit and a target baking parameter used to control the baking unit; and
the method further comprises:
determining a preset time point and obtain a stage image sequence corresponding to the preset time point, the stage image sequence including at least one gluing image and at least one baking image;
determining, based on the stage image sequence and substrate material data, gluing and baking quality data; and
determining, based on the gluing and baking quality data, the target gluing parameter and the target baking parameter.

8. The method of claim 7, wherein the at least one unit control parameter further includes a target film laminating parameter used to control the laminating unit and a target pressing parameter used to control the pressing unit, and the method further comprises:
obtaining one or more candidate film laminating parameters and one or more candidate pressing parameters; and
determining, based on a current gluing parameter, a current baking parameter, historical film laminating quality data, historical gluing and baking quality data, the one or more candidate film laminating parameters. and the one or more candidate pressing parameters, the target laminating parameter and the target pressing parameter.

9. A non-transitory computer-readable storage medium storing computer instructions, when reading the computer instructions in the storage medium, a computer performs a method including:
determining, based on an image data set, gluing quality data, wherein the image data set is acquired by an image acquisition unit of an automatic production line, and the image data set includes an original image data set and a gluing image data set;
determining, based on the gluing quality data, at least one control parameter; and
generating, based on the at least one control parameter, a control instruction, and send the control instruction to one of at least one production line unit to perform a production control, wherein the at least one production line unit includes a gluing unit, a laminating unit, a baking unit, a pressing unit, or the image acquisition unit.

10. The non-transitory computer-readable storage medium of claim 9, wherein the image data set further includes a film laminating image data set, and the at least one control parameter includes a test cycle, and the method further comprises:
determining, based on glue image data, the original image data set, and the gluing image data set, the gluing quality data;
obtaining, based on the film laminating image data set, film laminating quality data; and
determining, based on the gluing quality data, the film laminating quality data, and production quality data, the test cycle.

11. The non-transitory computer-readable storage medium of claim 9, wherein the image data set further includes a baking image data set, the at least one control parameter includes at least one unit control parameter, the at least one unit control parameter including a target gluing parameter used to control the gluing unit and a target baking parameter used to control the baking unit; and
the method further comprises:
determining a preset time point and obtain a stage image sequence corresponding to the preset time point, the stage image sequence including at least one gluing image and at least one baking image;
determining, based on the stage image sequence and substrate material data, gluing and baking quality data; and
determining, based on the gluing and baking quality data, the target gluing parameter and the target baking parameter.

12. The non-transitory computer-readable storage medium of claim 11, wherein the at least one unit control parameter further includes a target film laminating parameter used to control the laminating unit and a target pressing parameter used to control the pressing unit, and the method further comprises:
obtaining one or more candidate film laminating parameters and one or more candidate pressing parameters; and
determining, based on a current gluing parameter, a current baking parameter, historical film laminating quality data, historical gluing and baking quality data, the one or more candidate film laminating parameters. and the one or more candidate pressing parameters, the target laminating parameter and the target pressing parameter.
